(19) United States
(12) Patent Application Publication
(10) Pub. No.: US 2023/0104951 A1
(43) Pub. Date: Apr. 6, 2023

(54) VEHICLE CONTROL APPARATUS

(71) Applicant: Mitsubishi Electric Corporation, Tokyo (JP)

(72) Inventor: Mizuho WAKABAYASHI, Tokyo (JP)

(73) Assignee: Mitsubishi Electric Corporation, Tokyo (JP)

(21) Appl. No.: 17/891,725

(22) Filed: Aug. 19, 2022

(30) Foreign Application Priority Data
Oct. 1, 2021 (JP) 2021-162489

(51) Int. Cl. B60W 30/18; B60W 30/16; B60W 30/14; B60W 30/095; B60W 40/105; B60W 40/04; B60W 40/06; B60W 60/00

(52) U.S. Cl. CPC B60W 30/18163; B60W 30/16; B60W 30/143; B60W 30/0956; B60W 40/105; B60W 40/04; B60W 40/06; B60W 60/0053; B60W 2552/53; B60W 2554/4041; B60W 2554/80

(57) ABSTRACT

For a vehicle on a lane, a vehicle control apparatus obtains road information, calculates a dead-angle zone on an another lane based on the road information and the position of the own vehicle, and then decides to start a lane-changing feasibility determination, based on the position of the own vehicle and the position of an imaginary vehicle imagined at a position that is within the dead-angle zone. In the case where it is decided to start the lane-changing feasibility determination, the vehicle control apparatus determines whether or not lane changing is feasible, based on the position and the speed of the own vehicle and the position and the speed of another vehicle; in the case where it is determined that the lane changing is feasible, the vehicle control apparatus makes the own vehicle perform lane changing to said another lane.

### TECHNICAL FIELD

The present disclosure relates to a vehicle control apparatus.

### BACKGROUND ART

There has been proposed a vehicle control apparatus for realizing autonomous driving of a vehicle. With regard to a vehicle capable of performing autonomous driving, there has been disclosed a technology related to a vehicle control apparatus that autonomously changes traffic lanes from a communication path to a main lane through a speed-changing lane on an expressway or the like. There exists a technology in which it is determined whether or not lane changing from a speed-changing lane can be performed, in accordance with an inter-vehicle distance between an own vehicle and another vehicle traveling on a main lane, and then the lane changing is started at an appropriate timing.

Patent Document 1 discloses a vehicle control apparatus, for supporting lane changing, that determines whether or not lane changing to a main lane can be performed while continuing autonomous driving, based on the position of another vehicle and the shape of a road. When determining that the lane changing to the main lane can be performed while continuing autonomous driving, the vehicle control apparatus requests the driver to perform manual operation.

### CITATION LIST

### Patent Literature

Patent Document 1: Japanese Patent Application Laid-Open No. 2020-91778

In the technology disclosed in Patent Document 1, outside-monitoring vehicle sensors such as a camera and a radar are provided in a vehicle; thus, the position, the speed, and the like of another vehicle can be detected. In some cases, lane changing from a communication path to a main lane through a speed-changing lane is performed on an expressway or the like. This lane changing will be referred to as merging. When the communication path merges with the main lane, the lane changing is performed while securing an inter-vehicle distance by recognizing the position and the speed of another vehicle traveling on the main lane.

In a place where lane changing for merging is performed, there may exist an obstacle such as a pole, a guard rail, or a wall around a position where connection between a lane on which an own vehicle is traveling and another lane is started. In some cases, the effect of such an obstacle causes a dead-angle zone and hence another vehicle traveling on another lane cannot be detected by a vehicle sensor. Accordingly, in the case where another vehicle exists in the dead-angle zone of the vehicle sensor, it is conceivable that said another vehicle cannot be detected and hence the own vehicle abnormally approaches said another vehicle. In this case, said another vehicle may be decelerated.

### SUMMARY OF INVENTION

The present disclosure has been implemented in order to solve the foregoing problem. The objective thereof is to obtain a vehicle control apparatus in which when lane changing from a traveling lane to another lane is performed, the dead angle of an obstacle is considered and a lane-changing feasibility determination is started after the state where another vehicle traveling on another lane can sufficiently be detected has been realized, so that abnormal approach to said another vehicle existing in the dead-angle zone is prevented.

### Solution to Problem

A vehicle control apparatus according to the present disclosure includes

an own-vehicle-information detection unit for detecting a position and a speed of an own vehicle that performs lane changing from one lane to another lane,

an another-vehicle-information detection unit for detecting a position and a speed of another vehicle traveling on said another lane, by means of a sensor provided in the own vehicle,

a road-information acquisition unit for acquiring road information indicating respective road positions that specify the one lane and said another lane,

a dead-angle-zone calculation unit for calculating a dead-angle zone that is a zone within a dead angle on said another lane when viewed from the own vehicle, based on the road information acquired by the road-information acquisition unit and a position of the own vehicle detected by the own-vehicle-information detection unit,

a lane-changing-feasibility-determination start decision unit for deciding to start a lane-changing feasibility determination, based on a position of the own vehicle and a position of an imaginary vehicle imagined at a position that is within the dead-angle zone calculated by the dead-angle-zone calculation unit and is nearest to the own vehicle,

a lane-changing feasibility determination unit for determining whether or not lane changing is feasible, based on a position and a speed of the own vehicle and a position and a speed of said another vehicle, in the case where the lane-changing-feasibility-determination start decision unit decides to start a lane-changing feasibility determination, and

a traveling control unit for making the own vehicle perform lane changing to another lane, in the case where the lane-changing feasibility determination unit determines that lane changing is feasible.

### Advantage of Invention

In a vehicle control apparatus according to the present disclosure, when lane changing from a traveling lane to another lane is performed, the dead angle of an obstacle is considered and a lane-changing feasibility determination is started after the state where another vehicle traveling on said another lane can sufficiently be detected has been realized, so that abnormal approach to said another vehicle existing in the dead-angle zone can be prevented.

### BRIEF DESCRIPTION OF DRAWINGS

FIG. 1 is a configuration diagram of a vehicle control apparatus according to Embodiment 1;

FIG. 2 is a hardware configuration diagram of the vehicle control apparatus according to Embodiment 1;

FIG. 3 is a first drawing representing a road merging point according to Embodiment 1;

FIG. 4 is a second drawing representing the road merging point according to Embodiment 1;

FIG. 5 is a graph representing the relationship between an imaginary approaching speed and an imaginary inter-vehicle distance threshold value according to Embodiment 1;

FIG. 6 is a third drawing representing the road merging point according to Embodiment 1;

FIG. 7 is a fourth drawing representing the road merging point according to Embodiment 1;

FIG. 8 is a graph representing the relationship between a front approaching speed of a preceding vehicle and a front inter-vehicle distance threshold value according to Embodiment 1;

FIG. 9 is a graph representing the relationship between a rear approaching speed of a following vehicle and a rear inter-vehicle distance threshold value according to Embodiment 1;

FIG. 10 is a first flowchart representing processing of the vehicle control apparatus according to Embodiment 1;

FIG. 11 is a second flowchart representing the processing of the vehicle control apparatus according to Embodiment 1;

FIG. 12 is a configuration diagram of a vehicle control apparatus according to Embodiment 2;

FIG. 13 is a drawing representing a road merging point according to Embodiment 2;

FIG. 14 is a flowchart representing processing of the vehicle control apparatus according to Embodiment 2;

FIG. 15 is a configuration diagram of a vehicle control apparatus according to Embodiment 3;

FIG. 16 is a drawing representing a road merging point according to Embodiment 3;

FIG. 17 is a configuration diagram of a vehicle control apparatus according to Embodiment 4;

FIG. 18 is a flowchart representing processing of the vehicle control apparatus according to Embodiment 4;

FIG. 19 is a configuration diagram of a vehicle control apparatus according to Embodiment 5;

FIG. 20 is a flowchart representing processing of the vehicle control apparatus according to Embodiment 5;

FIG. 21 is a configuration diagram of a vehicle control apparatus according to Embodiment 6;

FIG. 22 is a first flowchart representing processing of the vehicle control apparatus according to Embodiment 6;

FIG. 23 is a second flowchart representing the processing of the vehicle control apparatus according to Embodiment 6;

FIG. 24 is a configuration diagram of a vehicle control apparatus according to Embodiment 7; and

FIG. 25 is a flowchart representing processing of the vehicle control apparatus according to Embodiment 7.

### DESCRIPTION OF EMBODIMENTS

### 1. Embodiment 1

### <Configuration of Vehicle Control Apparatus>

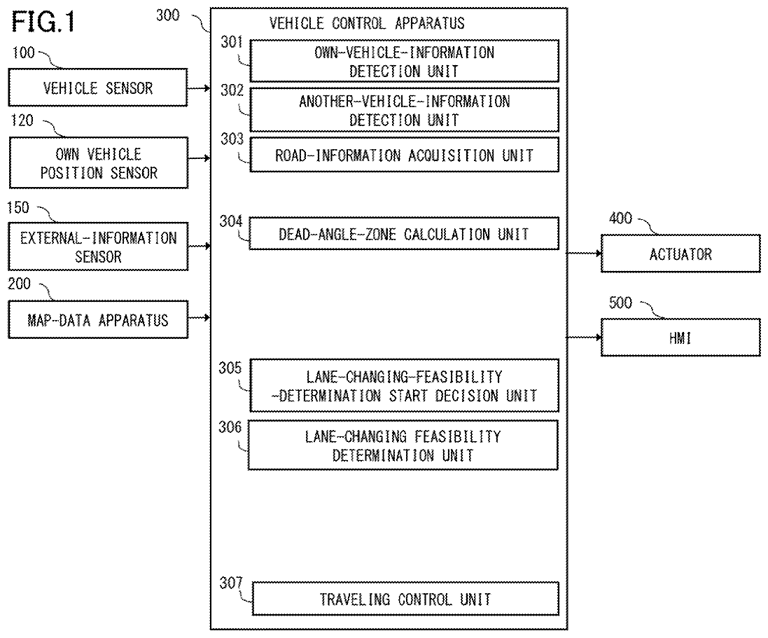

FIG. 1 is a configuration diagram of a vehicle control apparatus 300 according to Embodiment 1. The vehicle control apparatus 300 receives signals from a vehicle sensor 100, an own-vehicle positon sensor 120, and an external-information sensor 150 that are mounted in a vehicle. Then, the vehicle control apparatus 300 outputs signals to an actuator 400 and an HMI (Human Machine Interface) 500 that are mounted in the vehicle.

The vehicle sensor 100 includes a group of sensors, such as a vehicle speed sensor, an acceleration sensor, a yaw-rate sensor (an angular acceleration sensor), and the like, that are incorporated in the vehicle. The own-vehicle positon sensor 120 is configured with an apparatus such as a GPS (Global Positioning System) that can recognize the position of an own vehicle. The external-information sensor 150 includes sensors, such as a camera, a radar, and a LiDAR (Light Detection And Ranging), that are mounted in the vehicle, and can detect another vehicle outside the own vehicle, signs around a road, an obstacle, a landmark, and the like. A map-data apparatus 200 stores road information; the vehicle utilize the road information in order to perform autonomous running. The vehicle control apparatus 300 can obtain road information related to the vicinity of a traveling area of the vehicle each time the vehicle moves.

The actuator 400 includes an electric power steering apparatus, a wheel driving apparatus, a braking apparatus, a gear-changing apparatus, and the like, and is controlled by the vehicle control apparatus 300. In addition, the vehicle control apparatus 300 can transfer information to a driver through the HMI 500. The HMI 500 includes a liquid-crystal display, a sound-output speaker, a buzzer, a lamp, and the like.

### <Function Block of Vehicle Control Apparatus>

Function blocks provided in the vehicle control apparatus 300 are represented inside the vehicle control apparatus 300 in FIG. 1. The vehicle control apparatus 300 has an own-vehicle-information detection unit 301, an another-vehicle-information detection unit 302, a road-information acquisition unit 303, a dead-angle-zone calculation unit 304, a lane-changing-feasibility-determination start decision unit 305, a lane-changing feasibility determination unit 306, and a traveling control unit 307.

The own-vehicle-information detection unit 301 obtains information items related to a traveling state, such as the speed, the acceleration, the turning acceleration, and the like of the own vehicle, from the vehicle speed sensor, the acceleration sensor, the yaw-rate sensor, and the like included in the vehicle sensor 100. Moreover, the own-vehicle-information detection unit 301 obtains information related to the position of the own vehicle from the own-vehicle positon sensor 120. The respective information items on the vehicle speed, the acceleration, and the turning acceleration may be obtained from the wheel rotation speed and the outputs of a G sensor and a rotation-angle acceleration sensor that are mounted in the respective directions of the vehicle body. However, it may be allowed that the respective information items on the vehicle speed, the acceleration, and the turning acceleration may be obtained from the output of the GPS system. The own-vehicle-information detection unit 301 can detect the position and the speed of the own vehicle.

The another-vehicle-information detection unit 302 can detect the position and the speed of another vehicle outside the own vehicle from the signals of the external-information sensor 150 including a camera, a radar, a LiDAR, and the like. The another-vehicle-information detection unit 302 may further detect the traveling state of another vehicle, including the acceleration, the rotation-angle speed, and the rotation-angle acceleration.

The road-information acquisition unit 303 receives the present position of the own vehicle and road information on the surrounding area thereof from the map-data apparatus 200. In order to cope with road merging and lane changing, the road-information acquisition unit 303 obtains road information indicating respective road positions that specify the lane on which the own vehicle is traveling and another lane to which lane changing is to be performed.

The dead-angle-zone calculation unit 304 calculates a dead-angle zone, based on the road information acquired by the road-information acquisition unit 303 and the position of the own vehicle detected by the own-vehicle-information detection unit 301. The dead-angle zone denotes a zone within a dead angle on another lane to which lane changing is to be performed, when viewed from the own vehicle on the lane on which the own vehicle is traveling. The dead-angle zone is a zone about which it is considered that another vehicle therein cannot be detected by the external-information sensor 150 mounted in the own vehicle.

The lane-changing-feasibility-determination start decision unit 305 assumes that another vehicle exists in the dead-angle zone calculated by the dead-angle-zone calculation unit 304. The lane-changing-feasibility-determination start decision unit 305 assumes that another vehicle exists at a position nearest to the own vehicle in the dead-angle zone; this vehicle will be referred to as an imaginary vehicle. Based on the present position of the own vehicle and the position of the imaginary vehicle, the lane-changing-feasibility-determination start decision unit 305 determines whether or not a lane-changing feasibility determination can be started. When a sufficient inter-vehicle distance exists between the imaginary vehicle and the own vehicle, it can be determined that appropriate lane changing can be planned without abnormally approaching the imaginary vehicle, even when the imaginary vehicle exists. Accordingly, in this case, the lane-changing feasibility determination unit 306 can start the lane-changing feasibility determination, while considering, for example, the existence of another vehicle in a place other than the dead-angle zone.

In the case where the lane-changing-feasibility-determination start decision unit 305 decides to start the lane-changing feasibility determination, the lane-changing feasibility determination unit 306 determines whether or not lane changing can be performed, based on the position and the speed of the own vehicle and the position and the speed of another vehicle. Specifically, the lane-changing feasibility determination unit 306 determines whether or not lane changing can be performed, based on whether or not there exists an inter-vehicle distance, for avoiding abnormal approach, between the own vehicle and a preceding vehicle or a following vehicle on another lane to which lane changing is to be performed.

In the case where the lane-changing feasibility determination unit 306 determines that lane changing is feasible, the traveling control unit 307 makes the own vehicle change the present lane to another lane. The traveling control unit 307 transmits an output signal to the actuator 400 so as to control the vehicle by operating the electric power steering apparatus, the wheel driving apparatus, the braking apparatus, the gear-changing apparatus, and the like.

### <Hardware Configuration of Vehicle Control Apparatus>

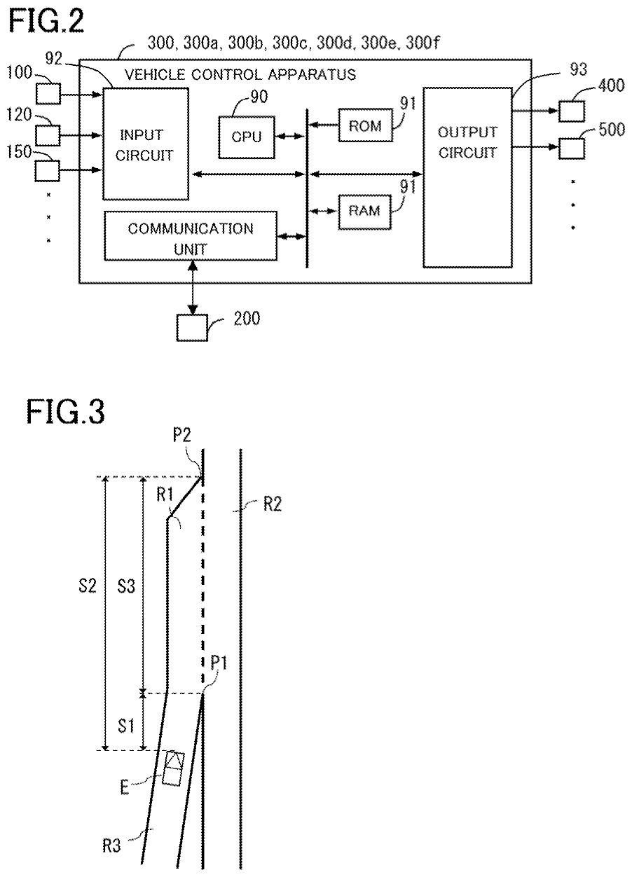

FIG. 2 is a hardware configuration diagram of the vehicle control apparatus 300. The hardware configuration in FIG. 2 can be applied also to each of vehicle control apparatuses 300a, 300b, 300c, 300d, 300e, and 300f. In the present embodiment, as the representative apparatus thereof, the vehicle control apparatus 300 will be explained. In the present embodiment, the vehicle control apparatus 300 is an electronic control apparatus for realizing autonomous driving of a vehicle. Respective functions of the vehicle control apparatus 300 are realized by processing circuits provided in the vehicle control apparatus 300. Specifically, the vehicle control apparatus 300 includes, as the processing circuits, a computing processing unit (computer) 90 such as a CPU (Central Processing Unit), storage apparatuses 91 that exchange data with the computing processing unit 90, an input circuit 92 that inputs external signals to the computing processing unit 90, an output circuit 93 that outputs signals from the computing processing unit 90 to the outside, and the like.

It may be allowed that as the computing processing unit 90, an ASIC (Application Specific Integrated Circuit), an IC (Integrated Circuit), a DSP (Digital Signal Processor), an FPGA (Field Programmable Gate Array), each of various kinds of logic circuits, each of various kinds of signal processing circuits, or the like is provided. In addition, it may be allowed that as the computing processing unit 90, two or more computing processing units of the same type or different types are provided and respective processing items are executed in a sharing manner. As the storage apparatuses 91, there are provided a RAM (Random Access Memory) that can read data from and write data in the computing processing unit 90, a ROM (Read Only Memory) that can read data from the computing processing unit 90, and the like. As the storage apparatus 91, a nonvolatile or volatile semiconductor memory such as a flash memory, an EPROM, or an EEPROM, a magnetic disk, a flexible disk, an optical disk, a compact disk, a minidisk, a DVD, or the like may be utilized. The input circuit 92 is connected with various kinds of sensors including the vehicle sensor group 100, the own-vehicle positon sensor 120, and the output signal of the external-information sensor 150, switches, and communication lines, and is provided with an A/D converter, a communication circuit, and the like for inputting output signals from these sensors and switches and communication information to the computing processing unit 90. The output circuit 93 is provided with a driving circuit and the like for outputting control signals from the computing processing unit 90 to apparatuses including the actuator 400 and the HMI 500. The computing processing unit 90 can communicate with external apparatuses including the map-data apparatus 200 through a communication unit.

The computing processing unit 90 executes software items (programs) stored in the storage apparatus 91 such as a ROM and collaborates with other hardware devices in the vehicle control apparatus 300, such as the storage apparatus 91, the input circuit 92, and the output circuit 93, so that the respective functions provided in the vehicle control apparatus 300 are realized. Setting data items such as a threshold value and a determination value to be utilized in the vehicle control apparatus 300 are stored, as part of software items (programs), in the storage apparatus 91 such as a ROM. It may be allowed that the respective functions included in the vehicle control apparatus 300 are configured with either software modules or combinations of software and hardware.

### <Road Merging and Lane Changing>

FIG. 3 is a first drawing representing a road merging point according to Embodiment 1. FIG. 3 represents a case where at an interchange of an expressway, lane changing from a communication path R3 to a main lane R2 through a speed-changing lane R1 is made so that road merging is made. In order to cope with road merging and lane changing, the road-information acquisition unit 303 obtains road-position indicating road information that specifies the communication path R3 on which an own vehicle E is traveling, the speed-changing lane R1, and the main lane R2 to which lane changing is to be performed.

In FIG. 3, the own vehicle E is traveling on the communication path R3 before the merging point. The point where connection between the speed-changing lane R1 and the main lane R2 is started is indicated as a connection starting point P1. The connection starting point P1 is a position where no obstacle exists between the speed-changing lane R1 and the main lane R2 and merging can physically be started, and is referred to as a hard nose or a soft nose. The point where the connection between the speed-changing lane R1 and the main lane R2 ends is indicated as a speed-changing-lane ending point P2. A specific section before the speed-changing-lane ending point P2 is referred to as a taper where the width of the speed-changing lane gradually narrows.

The distance between the present position of the own vehicle E and the speed-changing-lane ending point P2 is indicated as a speed-changing-lane pre-ending distance S2. The distance between the present position of the own vehicle E and the connection starting point P1 is indicated as a speed-changing-lane pre-connection distance S1. The distance between the connection starting point P1 and the speed-changing-lane ending point P2 is indicated as a speed-changing-lane distance S3. In this situation, the speed-changing-lane pre-connection distance S1 and the speed-changing-lane pre-ending distance S2 may be replaced by the respective distances between the front-end position of the own vehicle E, projected on the main lane, and the connection starting point P1 and between the front-end position of the own vehicle E, projected on the main lane, and the speed-changing-lane ending point P2; the respective distances are defined in the middle portion of the main lane R2.

### <Calculation of Dead-Angle Zone>

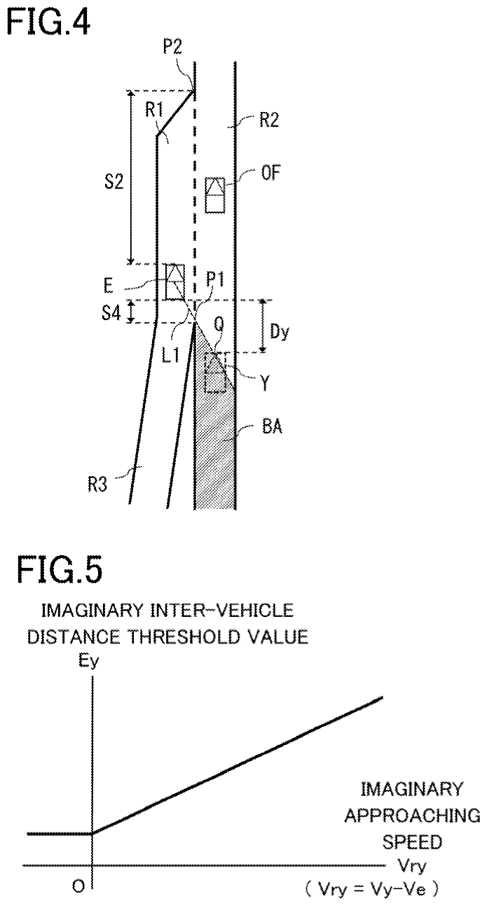

FIG. 4 is a second drawing representing the road merging point according to Embodiment 1. In FIG. 4, the own vehicle E is indicated on the speed-changing lane R1. The distance between the present position of the own vehicle E and the connection starting point P1 is indicated as a speed-changing-lane post-connection distance S4. The distance between the present position of the own vehicle E and the speed-changing-lane ending point P2 is indicated as the speed-changing-lane pre-ending distance S2. In this situation, the speed-changing-lane post-connection distance S4 may be replaced by the distance between the rear-end position of the own vehicle E, projected on the main lane, and the connection starting point P1; the foregoing distance is defined in the middle portion of the main lane R2. As is the case with FIG. 3, the speed-changing-lane pre-ending distance S2 may be replaced by the distance between the front-end position of the own vehicle E, projected on the main lane, and the speed-changing-lane ending point P2; the foregoing distance is defined in the middle portion of the main lane R2.

In FIG. 4, there are provided a side wall such as a tunnel wall, a sound insulation wall, or a blind wall or a guard rail, a road sigh, a tree, and the like, and hence the case where a dead-angle zone is caused will be anticipated. No obstacle is provided in the section between the connection starting point P1 and the speed-changing-lane ending point P2 so that free lane changing from the speed-changing lane R1 to the main lane R2 can be made. Accordingly, no dead-angle zone is caused in the section between the connection starting point P1 and the speed-changing-lane ending point P2.

As illustrated in FIG. 4, a dead-angle zone BA is caused at the left side of the main lane R2 (the side connecting with the speed-changing lane R1) up to the connection starting point P1, when viewed from the own vehicle E. In FIG. 4, the dead-angle zone BA is indicated by hatching (halftone dot meshing). The dead-angle boundary line L1 of the dead-angle zone BA on the main lane R2 can be specified on the extended line of a line connecting the connection starting point P1 with the mounting position of the external-information sensor 150 mounted in the own vehicle E.

The dead-angle-zone calculation unit 304 calculates the dead-angle zone BA, based on the road information including the positions of the communication path R3, the speed-changing lane R1, and the main lane R2, acquired by the road-information acquisition unit 303, and the position of the own vehicle E. The point where the dead-angle boundary line L1 included in the dead-angle zone BA and the center line of the main lane intersect each other is calculated as a dead-angle boundary point Q. It is imagined that the own vehicle exists on the dead-angle boundary point Q. This own vehicle is indicated as an imaginary vehicle Y. The imaginary vehicle Y is imagined at a position that is within the dead-angle zone BA and is nearest to the own vehicle E. The lane-changing-feasibility-determination start decision unit 305 determines whether or not a lane-changing feasibility determination can be started, while assuming the case where the imaginary vehicle Y exists on the dead-angle boundary point Q.

In FIG. 4, the distance between the present position of the own vehicle E and the dead-angle boundary point Q where the imaginary vehicle Y exists is indicated as an imaginary inter-vehicle distance Dy. It may be allowed that the imaginary inter-vehicle distance Dy is a distance that is the one between the position where the rear-end position of the own vehicle E is projected on the main lane R2 and the dead-angle boundary point Q indicating the front-end position of the imaginary vehicle Y and that is defined in the middle portion of the main lane R2.

In the case where when the imaginary inter-vehicle distance Dy and an imaginary inter-vehicle distance threshold value Ey are compared with each other, the imaginary inter-vehicle distance Dy is larger than the imaginary inter-vehicle distance threshold value Ey, the lane-changing-feasibility-determination start decision unit 305 decides to start the lane-changing feasibility determination. This is because the imaginary inter-vehicle distance Dy is sufficiently large and hence even when the imaginary vehicle Y exists, the own vehicle E does not abnormally approach the imaginary vehicle Y at a time of lane changing.

### <Distance Between Own Vehicle and Imaginary Vehicle>

It may be allowed that the imaginary inter-vehicle distance threshold value Ey is obtained from a speed Ve of the own vehicle E and a speed Vy of the imaginary vehicle Y. An imaginary approaching speed (imaginary relative speed) Vry can be obtained from the equation [Vry=Vy−Ve].

FIG. 5 is a graph representing the relationship between the imaginary approaching speed Vry of the imaginary vehicle and the imaginary inter-vehicle distance threshold value Ey according to Embodiment 1. In FIG. 5, as the imaginary approaching speed Vry between the own vehicle E and the imaginary vehicle Y becomes larger, the imaginary inter-vehicle distance threshold value Ey becomes larger. In the case where the imaginary approaching speed Vry between the own vehicle E and the imaginary vehicle Y is smaller than 0 (in the case where the imaginary approaching speed Vry becomes a negative value), there is represented a state where the distance between the both vehicles are becoming larger. Even in this case, the imaginary inter-vehicle distance threshold value Ey is secured as a constant finite value. When as the imaginary inter-vehicle distance threshold value Ey, a constant distance is secured, abnormal approach between the own vehicle and another vehicle can be prevented even when said another vehicle appears from the dead-angle zone.

The own vehicle E moves from the communication path R3 to the speed-changing lane R1 and then travels the speed-changing-lane post-connection distance S4, so that the imaginary inter-vehicle distance Dy can be secured. Because even when the imaginary vehicle Y appears after the imaginary inter-vehicle distance Dy has become larger than the imaginary inter-vehicle distance threshold value Ey, no abnormal approach occurs and hence lane changing can be planned, the lane-changing-feasibility-determination start decision unit 305 can decide to start the lane-changing feasibility determination.

### <Estimation of Speed of Imaginary Vehicle>

Here, an estimation method for the speed Vy of the imaginary vehicle Y will be explained. In the case where as represented in FIG. 4, a preceding vehicle OF is traveling in front of the own vehicle E on the main lane R2, it may be allowed that the speed Vy of the imaginary vehicle Y is estimated from a speed Vof of the preceding vehicle OF. From the speed of another vehicle actually traveling on the main lane, the speed Vy of the imaginary vehicle that is possibly traveling after said another vehicle can be estimated.

It may be allowed that the speed Vof of the preceding vehicle OF is directly utilized as the speed Vy of the imaginary vehicle Y. In addition, it may also be allowed that the speed Vy of the imaginary vehicle Y is obtained by multiplying the speed Vof of the preceding vehicle OF by a predetermined coefficient (for example, 1.2). Multiplication by the coefficient results in further prevention of abnormal approach between the own vehicle and another vehicle.

In addition, it may be allowed that a maximum speed specified for the main lane R2 is utilized as the speed Vy of the imaginary vehicle Y. From the maximum speed actually specified for the main lane R2, the speed Vy of the imaginary vehicle that is possibly traveling can be estimated. In addition, it may also be allowed that the speed Vy of the imaginary vehicle Y is obtained by multiplying the maximum speed specified for the main lane R2 by a predetermined coefficient (for example, 1.2). Multiplication by the coefficient results in further prevention of abnormal approach between the own vehicle and another vehicle.

### <In the Case Where no Dead-Angle Zone is Caused>

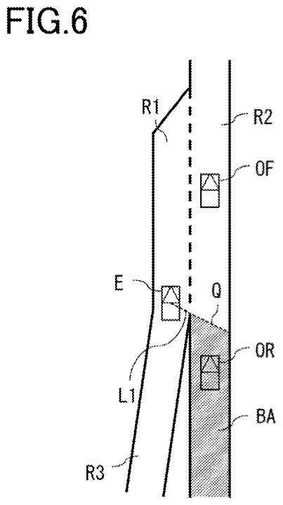

FIG. 6 is a third drawing representing the road merging point according to Embodiment 1. FIG. 6 represents the case where a following vehicle OR is detected after the dead-angle boundary point Q. Based on the fact that another vehicle can be detected after the dead-angle boundary point Q, it can be determined that no obstacle that obstructs the visual field of the external-information sensor 150 of the own vehicle E exists between the speed-changing lane R1 and the main lane R2. In this case, because it is not required to consider the imaginary vehicle Y, the lane-changing-feasibility-determination start decision unit 305 can decide to start the lane-changing feasibility determination.

In FIG. 4, there has been imagined a case where because an obstacle such as a side wall is provided up to the connection starting point P1 on the side surface of the main lane R2, the dead-angle zone BA is caused. However, the dead-angle zone BA is not necessarily caused at each of the merging points. It may be allowed that information related to whether or not the dead-angle zone BA is caused is integrated in the road information and only in the case where the dead-angle zone BA exists, the dead-angle zone BA is calculated in order to consider the imaginary vehicle Y.

In addition, it may be allowed that in the case of merging in which the communication path R3, the speed-changing lane R1, and the main lane R2 exist, the dead-angle zone BA is calculated assuming in principle that the dead-angle zone BA exists. In that case, when the following vehicle OR is detected after the dead-angle boundary point Q, it is determined that no dead-angle zone caused by an obstacle exists. Then, the lane-changing-feasibility-determination start decision unit 305 decides to start the lane-changing feasibility determination. Moreover, also when the following vehicle OR is detected before the dead-angle boundary point Q, it is not required to consider the imaginary vehicle Y; thus, the lane-changing-feasibility-determination start decision unit 305 may decide to start the lane-changing feasibility determination.

### <Preceding Vehicle, Following Vehicle>

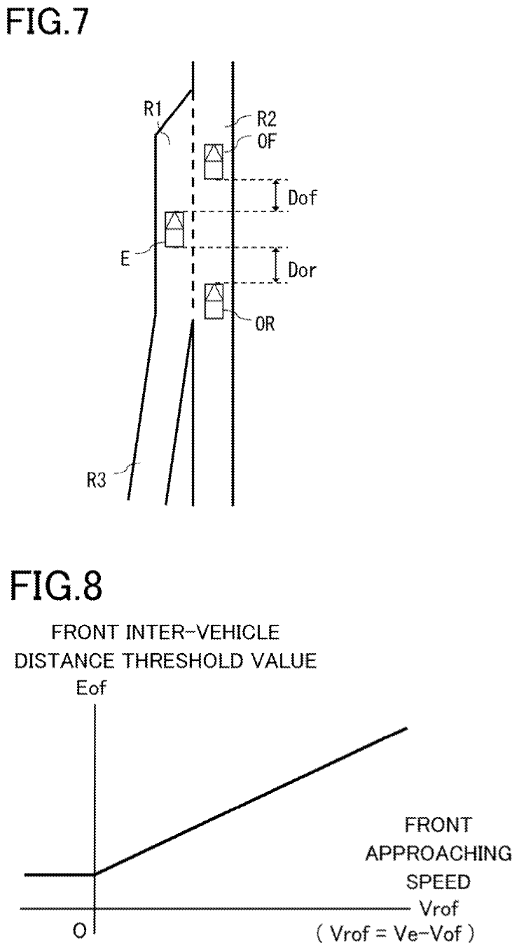

FIG. 7 is a fourth drawing representing the road merging point according to Embodiment 1. In FIG. 7, the preceding vehicle OF exists on the main lane R2 in front of the own vehicle E traveling on the speed-changing lane R1. In addition, the following vehicle OR exists on the main lane R2 after the own vehicle E.

### <Inter-Vehicle Distance Between Own Vehicle and Preceding Vehicle>

There will be explained the case where the external-information sensor 150 of the own vehicle E has detected the position and the speed Vof of the preceding vehicle OF. A front inter-vehicle distance Dof between the own vehicle E and the preceding vehicle OF is indicated. Based on the position and the speed Ve of the own vehicle E and the position and the speed Vof of the preceding vehicle OF, the lane-changing feasibility determination unit 306 determines whether or not lane changing is feasible.

It may be allowed that the front inter-vehicle distance Dof with which it is determined that lane changing is feasible is decided from the speed Ve of the own vehicle E and the speed Vof of the preceding vehicle OF. A front approaching speed Vrof is the difference between the speed Ve of the own vehicle E and the speed Vof of the preceding vehicle OF. The front approaching speed Vrof is defined by the equation [Vrof=Ve−Vof]. A front inter-vehicle distance threshold value Eof can be determined from the front approaching speed Vrof. In the case where the front inter-vehicle distance Dof between the preceding vehicle OF and the own vehicle E is smaller than the front inter-vehicle distance threshold value Eof, the lane-changing feasibility determination unit 306 can determine that the lane changing is not feasible. In contrast, in the case where the front inter-vehicle distance Dof is the same as or larger than the front inter-vehicle distance threshold value Eof, the lane-changing feasibility determination unit 306 can determine that the lane changing is feasible. This is because abnormal approach between the own vehicle E and the preceding vehicle OF can be prevented and hence the lane changing to (merging with) the main lane can be made in good time.

FIG. 8 is a graph representing the relationship between the front approaching speed Vrof of the preceding vehicle OF and the front inter-vehicle distance threshold value Eof according to Embodiment 1. As the front approaching speed Vrof between the own vehicle E and the preceding vehicle OF becomes larger, the front inter-vehicle distance threshold value Eof becomes larger. In the case where the front approaching speed Vrof between the own vehicle E and the preceding vehicle OF is smaller than 0 (in the case where the front approaching speed Vrof becomes a negative value), there is represented a state where the distance between the both vehicles are becoming larger. Even in this case, the front inter-vehicle distance threshold value Eof is secured as a constant finite value. This is because when the constant distance is secured as the front inter-vehicle distance threshold value Eof, abnormal approach between the own vehicle E and the preceding vehicle OF can be prevented and hence the lane changing to (merging with) the main lane can be made in good time.

### <Inter-Vehicle Distance Between Own Vehicle and Following Vehicle>

In FIG. 7, there will be explained the case where the external-information sensor 150 of the own vehicle E has detected the position and a speed Vor of the preceding vehicle OR. A rear inter-vehicle distance Dor between the own vehicle E and the following vehicle OR is indicated. Based on the position and the speed Ve of the own vehicle E and the position and the speed Vor of the following vehicle OR, the lane-changing feasibility determination unit 306 determines whether or not lane changing is feasible.

It may be allowed that the rear inter-vehicle distance Dor with which it is determined that lane changing is feasible is decided from the speed Ve of the own vehicle E and the speed Vor of the following vehicle OR. A rear approaching speed Vror is the difference between the speed Ve of the own vehicle E and the speed Vor of the following vehicle OR. The rear approaching speed Vror is defined by the equation [Vror=Vor−Ve]. A rear inter-vehicle distance threshold value Eor can be determined from the rear approaching speed Vror. In the case where the rear inter-vehicle distance Dor between the following vehicle OR and the own vehicle E is smaller than the rear inter-vehicle distance threshold value Eor, the lane-changing feasibility determination unit 306 can determine that the lane changing is not feasible. In contrast, in the case where the rear inter-vehicle distance Dor is the same as or larger than the rear inter-vehicle distance threshold value Eor, the lane-changing feasibility determination unit 306 can determine that the lane changing is feasible. This is because abnormal approach between the own vehicle E and the following vehicle OR can be prevented and hence the lane changing to (merging with) the main lane can be made in good time.

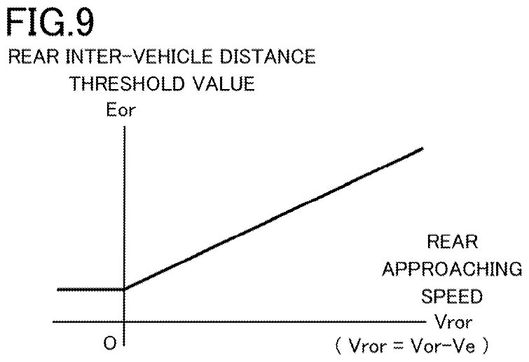

FIG. 9 is a graph representing the relationship between the rear approaching speed Vror of the following vehicle OR and the rear inter-vehicle distance threshold value Eor according to Embodiment 1. As the rear approaching speed Vror between the own vehicle E and the following vehicle OR becomes larger, the rear inter-vehicle distance threshold value Eor becomes larger. In the case where the rear approaching speed Vror between the own vehicle E and the following vehicle OR is smaller than 0 (in the case where the rear approaching speed Vror becomes a negative value), there is represented a state where the distance between the both vehicles are becoming larger. Even in this case, the rear inter-vehicle distance threshold value Eor is secured as a constant finite value. This is because when the constant distance is secured as the rear inter-vehicle distance threshold value Eor, abnormal approach between the own vehicle E and the following vehicle OR can be prevented and hence the lane changing to (merging with) the main lane can be made in good time.

### <Lane Changing (Merging)>

In the case where the lane-changing feasibility determination unit 306 determines that the lane changing is feasible, the traveling control unit 307 makes the own vehicle E autonomously travel up to the main lane R2 so as to perform the lane changing (merging). Specifically, the traveling control unit 307 transmits an output signal to the actuator 400 so as to control the vehicle and perform the lane changing (merging), by operating the electric power steering apparatus, the wheel driving apparatus, the braking apparatus, the gear-changing apparatus, and the like.

### <Processing in Vehicle Control Apparatus>

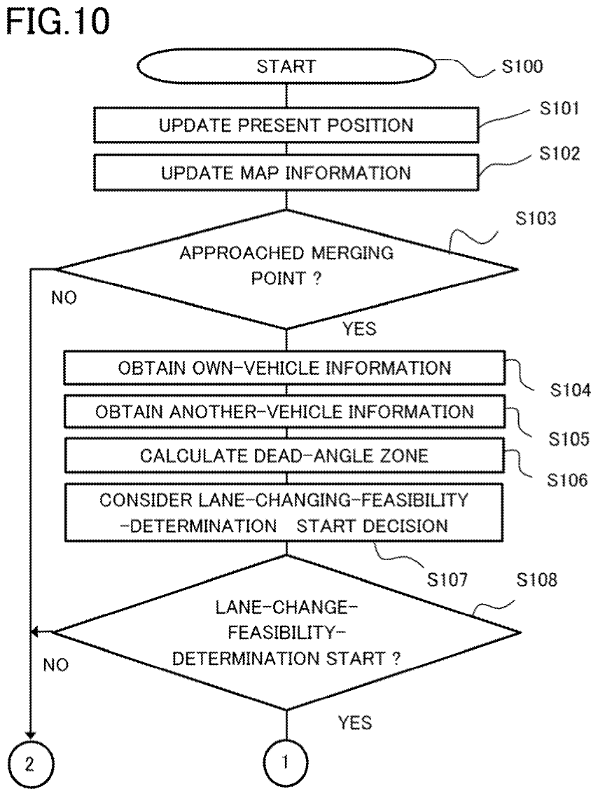

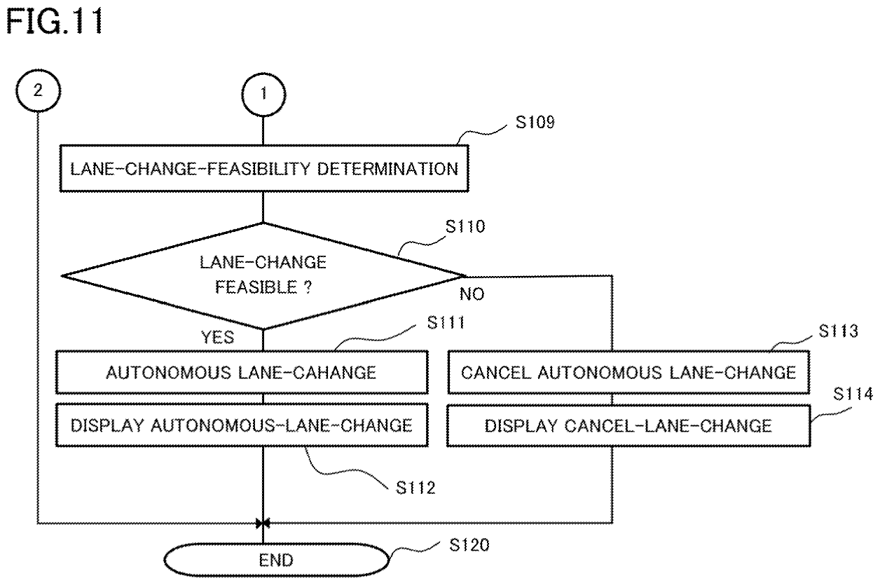

FIG. 10 is a first flowchart representing processing by the control apparatus 300 according to Embodiment 1. FIG. 11 is a second flowchart and represents the rest of the processing in the flowchart in FIG. 10.

The processing in the flowchart in FIG. 10 is performed every predetermined time (for example, every 10 ms). The processing represented in FIG. 10 may be performed not every predetermined time but every event, for example, each time the vehicle has traveled a predetermined distance or each time the external-information sensor 150 mounted in the vehicle has detected another vehicle, an obstacle, or the like.

The processing is started in the step S100; then, in the step S101, the own-vehicle positon sensor 120 updates the present position of the own vehicle E. Then, in the step S102, in response to the update of the present position, map information is updated, as may be necessary. Specifically, the vehicle control apparatus 300 receives necessary map information from the map-data apparatus 200. When the moving amount of the present position is minute and hence it is not required to update the map information, it is not necessary to newly receive map information.

In the step S103, it is determined whether or not the own vehicle E has approached a merging point. It is determined whether or not a determination on merging through lane changing is required at a time when the own vehicle approaches an interchange of an expressway including the communication path R3, the speed-changing lane R1, and the main lane R2. In the case where the own vehicle E has not approached a merging point (the determination is “NO”), the processing is ended in the step S120 in FIG. 11. In the case where the own vehicle E has approached a merging point (the determination is “YES”), the step S103 is followed by the step S104.

In the step S104, own-vehicle information detected by the own-vehicle-information detection unit 301 is obtained. In the step S105, another-vehicle information detected by the another-vehicle-information detection unit 302 is obtained. Then, in the step S106, the dead-angle-zone calculation unit 304 calculates the dead-angle zone BA, and the dead-angle boundary point Q is calculated. In the step S107, the lane-changing-feasibility-determination start decision unit 305 considers whether or not a lane-changing feasibility determination should be started. In the present embodiment, it is determined whether or not a sufficient distance is secured between the imaginary vehicle Y and the own vehicle E in the dead-angle zone BA. In the case where a sufficient distance is secured, the lane-changing feasibility determination is started.

In the step S108, whether or not the lane-changing feasibility determination should be started is decided. In the case where the lane-changing feasibility determination is not started (the determination is “NO”), the processing is ended in the step S120 in FIG. 11. In the case where the lane-changing feasibility determination is started (the determination is “YES”), the step S108 is followed by the step S109 in FIG. 11.

In the step S109 in FIG. 11, the lane-changing feasibility determination unit 306 performs the lane-changing feasibility determination. Specifically, it is determined whether or not lane changing causes any problem, based on the respective positions and the respective speeds of the preceding vehicle OF and the following vehicle OR on the main lane R2 and based on the position and the speed of the own vehicle E. In the step S110, it is determined whether or not the lane changing is feasible by ascertaining the determination result. In the case where the lane changing is feasible (the determination is “YES”), the step S110 is followed by the step S111. In the case where the lane changing is not feasible (the determination is “NO”), the step S110 is followed by the step S113.

In the step S111, the traveling control unit 307 controls the actuator 400 so as to perform autonomous lane changing operation. In the step S112, a signal is outputted to the HMI 500 so that the state “autonomous lane changing operation is being performed” is displayed. In this situation, the state “autonomous lane changing operation is being performed” may be notified to the driver through not only screen display but also audio output. After that, the processing is ended in the step S120.

In the step S113, processing for cancelling autonomous lane changing operation is performed. In the step S114, a signal is outputted to the HMI 500 so that the state “autonomous lane changing operation is being cancelled” is displayed. In this situation, the state “autonomous lane changing operation is being cancelled” may be notified to the driver through not only screen display but also audio output. After that, the processing is ended in the step S120.

### 2. Embodiment 2

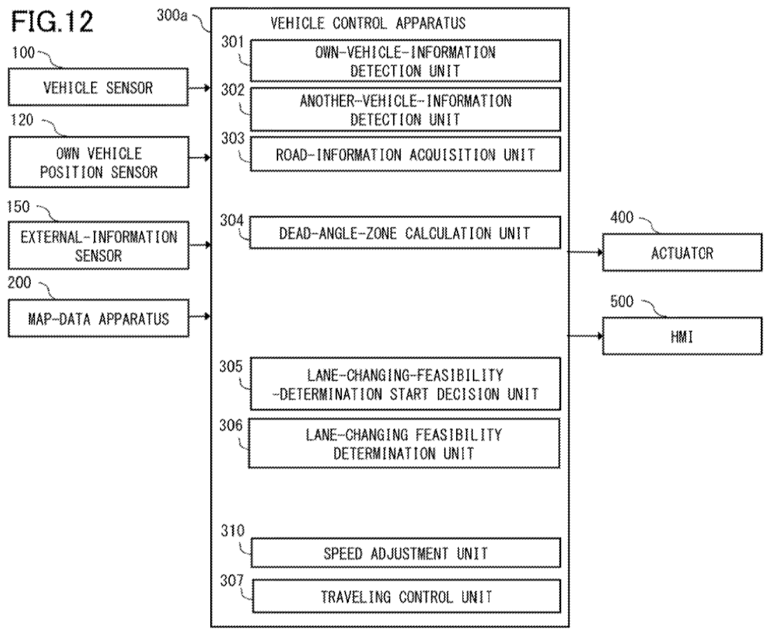

FIG. 12 is a configuration diagram of a vehicle control apparatus 300a according to Embodiment 2. The vehicle control apparatus 300a is different from the vehicle control apparatus 300, represented in FIG. 1, according to Embodiment 1 in that a speed adjustment unit 310 is added thereto. The explanations for the function units that perform the same operation items as those units according to Embodiment 1 do will be omitted.

In the case where the lane-changing feasibility determination unit 306 determines that lane changing is not feasible, the speed adjustment unit 310 adjusts the speed of the own vehicle E so as to extend the inter-vehicle distance between the own vehicle E and another vehicle traveling on the main lane R2 and to make the present state move to a state where lane changing (merging) is feasible. For example, the speed adjustment unit 310 determines a target speed so that the speed Ve of the own vehicle E becomes a lane-changing permission speed that is a lower speed and with which it is determined that lane changing is feasible.

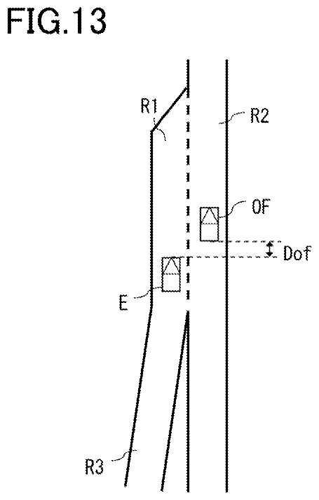

FIG. 13 is a drawing representing a road merging point according to Embodiment 2. In FIG. 3, the front inter-vehicle distance Dof, which is a distance between the preceding vehicle OF traveling on the main lane and the own vehicle E projected on the main lane, is indicated. In the case where the front inter-vehicle distance Dof is smaller than the front inter-vehicle distance threshold value Eof, the lane-changing feasibility determination unit 306 determines that lane changing is not feasible.

In this case, the speed adjustment unit 310 sets a target speed and outputs a signal to the actuator 400 so that the speed Ve of the own vehicle E is decreased in order to make the lane changing feasible by extending the front inter-vehicle distance Dof. Because as the speed Ve of the own vehicle E decreases, the front inter-vehicle distance Dof is extended, the front inter-vehicle distance Dof becomes the same as or larger than the front inter-vehicle distance threshold value Eof and hence the lane-changing feasibility determination unit 306 can determine that the lane changing is feasible.

In addition, because as the speed Ve of the own vehicle E decreases, the front approaching speed Vrof also decreases, the front inter-vehicle distance threshold value Eof becomes smaller and hence it is facilitated that the front inter-vehicle distance Dof becomes the same as or larger than the front inter-vehicle distance threshold value Eof. As a result, the lane changing (merging) becomes feasible.

In the case where the following vehicle OR is detected and the rear inter-vehicle distance Dor between the following vehicle OR and the own vehicle E is smaller than the rear inter-vehicle distance threshold value Eor, the lane-changing feasibility determination unit 306 determines that the lane changing is not feasible. Similarly in this case as well, the speed adjustment unit 310 sets a target speed so that the speed Ve of the own vehicle E becomes a lane-changing permission speed that is a higher speed and with which it is determined that lane changing is feasible. The speed adjustment by the speed adjustment unit 310 prevents the own vehicle from abnormally approaching the following vehicle OR and hence the lane changing (merging) becomes feasible.

In the case where the position of another vehicle traveling on the main lane is approaching the own vehicle E, it may be determined whether merging is made at the front side of said another vehicle or at the rear side of said another vehicle, based on the relative speed and the inter-vehicle distance between the own vehicle and said another vehicle. In the case where it is determined that merging is made at the front side of said another vehicle, the target speed is set for acceleration; in the case where it is determined that merging is made at the rear side of said another vehicle, the target speed is set for deceleration. Because in general, operation can be performed faster at a time of deceleration than at a time of acceleration, rapid deceleration can be performed by the braking apparatus. However, when another vehicle exists after the own vehicle E, it is required to take it into consideration that due to rapid deceleration, the own vehicle may be rear-ended.

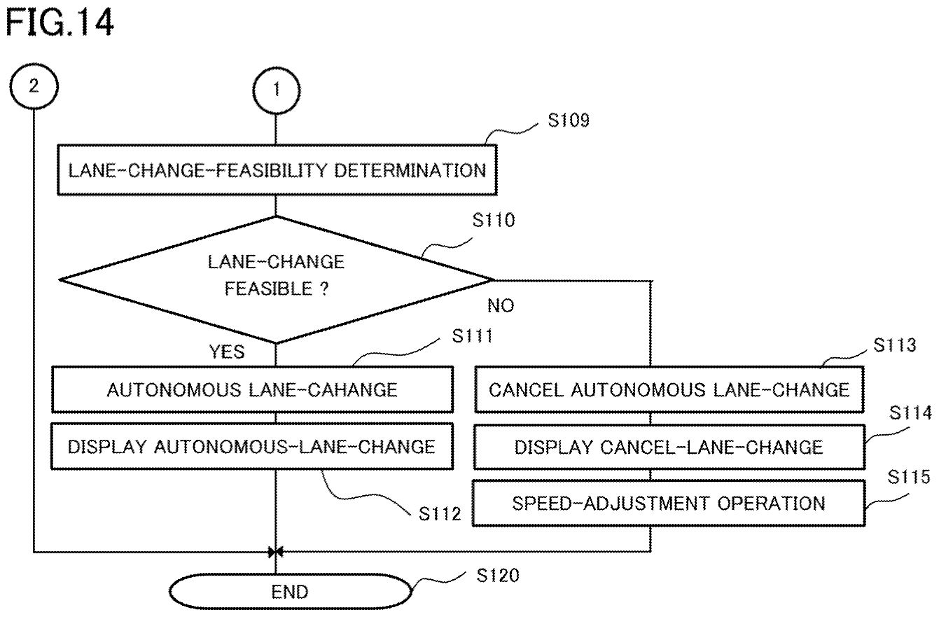

FIG. 14 is a flowchart representing processing by the control apparatus 300a according to Embodiment 2. The flowchart, in FIG. 10, of the processing by the vehicle control apparatus 300a according to Embodiment 2 is followed by the flowchart in FIG. 14. The flowchart in FIG. 14 is different from the flowchart in FIG. 11 according to Embodiment 1 in that the processing in the step S115 is added after the step S114. In the case where it is determined that lane changing is not feasible, speed-adjustment operation that is necessary for the lane changing to be determined feasible is performed in the step S115.

As described above, in the vehicle control apparatus 300a according to Embodiment 2, in the case where it is determined that lane changing (merging) is not feasible, speed adjustment is performed so as to extend the inter-vehicle distance between the own vehicle E and another vehicle traveling on the main lane R2, so that the lane changing (merging) is made feasible. As a result, a load on the driver is reduced, and the own vehicle can be prevented from reaching the speed-changing-lane ending point P2 while being not capable of performing the lane changing.

### 3. Embodiment 3

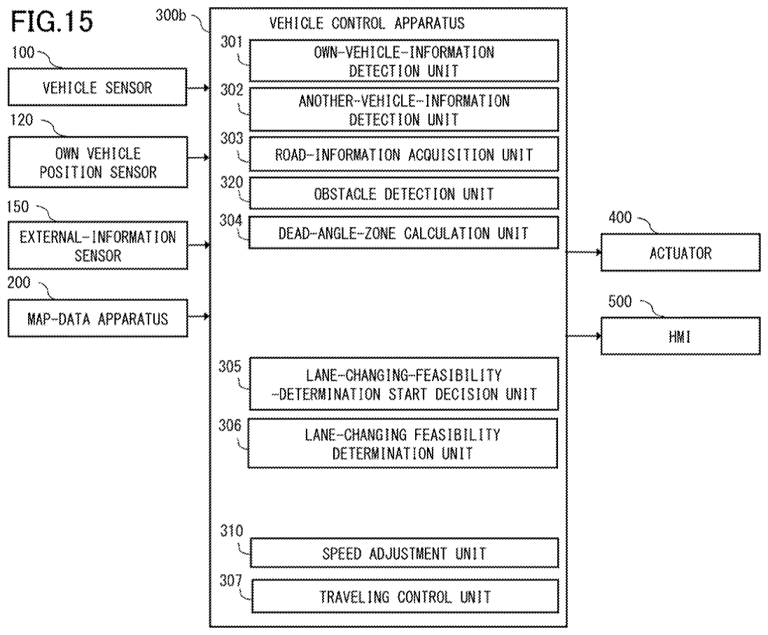

FIG. 15 is a configuration diagram of a vehicle control apparatus 300b according to Embodiment 3. The vehicle control apparatus 300b is different from the vehicle control apparatus 300a, represented in FIG. 12, according to Embodiment 2 in that an obstacle detection unit 320 is added thereto. The explanations for the function units that perform the same operation items as those units according to Embodiments 1 and 2 do will be omitted.

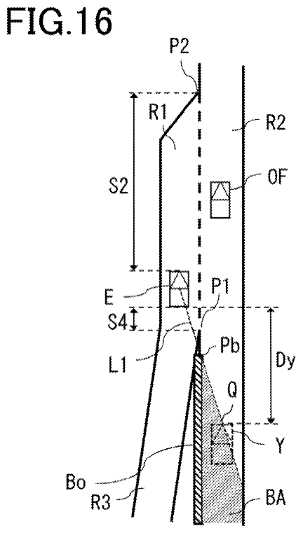

FIG. 16 is a drawing representing a road merging point according to Embodiment 3. FIG. 16 represents a state where as an obstacle Bo, a side wall is provided at the left side surface, of the main lane R2, that is situated before a point where the main lane R2 is connected with the speed-changing lane R1. In this case, no obstacle forming a dead angle is provided around the connection starting point P1 where connection between the speed-changing lane R1 and the main lane R2 starts.

Based on information items from the camera of the external-information sensor 150, the radar, the LiDAR, and the like, the obstacle detection unit 320 of the vehicle control apparatus 300b determines whether or not there exists the obstacle Bo such as a side wall among the communication path R3, the speed-changing lane R1, and the main lane R2 and detects an obstacle front-end position Pb. Then, the dead-angle-zone calculation unit 304 of the vehicle control apparatus 300b defines a line connecting the position of the own vehicle E with the obstacle front-end position Pb, as the dead-angle boundary line L1, and calculates the dead-angle boundary point Q where the dead-angle boundary line L1 and the center line of the main lane intersect each other and the imaginary inter-vehicle distance Dy between the present position of the own vehicle E and the dead-angle boundary point Q. The imaginary inter-vehicle distance Dy between the present position of the own vehicle E and the dead-angle boundary point Q may be replaced by a distance between the position of the own vehicle E projected on the main lane R2 and the dead-angle boundary point Q.

By use of the imaginary inter-vehicle distance Dy between the present position of the own vehicle E and the dead-angle boundary point Q obtained by the obstacle detection unit 320 and the dead-angle-zone calculation unit 304, the lane-changing-feasibility-determination start decision unit 305 of the vehicle control apparatus 300b performs processing the same as each of the processing items in Embodiments 1 and 2. As described above, Embodiment 3 makes it possible that the external-information sensor 150 detects an obstacle among the communication path R3, the speed-changing lane R1, and the main lane R2. Accordingly, it can be determined whether or not there exists an actual obstacle that cannot be distinguished by means of map information and road information obtained from the map-data apparatus 200. Thus, in practice, a decision for starting the lane-changing-feasibility determination and the determination on the lane-changing feasibility can be made at an early timing, in accordance with whether or not an obstacle exists. Accordingly, the lane changing (merging) can be performed in good time.

### 4. Embodiment 4

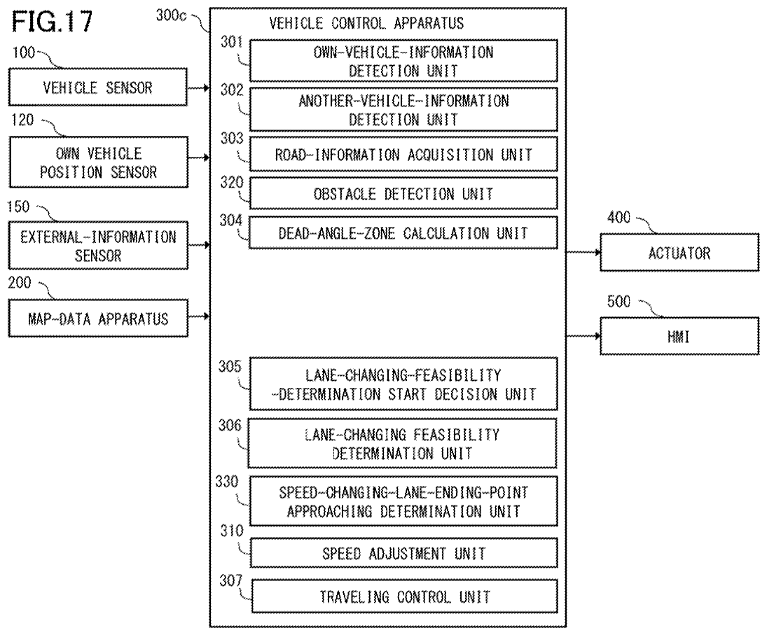

FIG. 17 is a configuration diagram of a vehicle control apparatus 300c according to Embodiment 4. The vehicle control apparatus 300c is different from the vehicle control apparatus 300b, represented in FIG. 15, according to Embodiment 3 in that a speed-changing-lane-ending-point approaching determination unit 330 is added thereto. The explanations for the function units that perform the same operation items as those units according to Embodiments 1 through 3 do will be omitted.

The speed-changing-lane-ending-point approaching determination unit 330 calculates a speed-changing-lane pre-ending distance S2, which is a distance between the present position of the own vehicle E and the speed-changing-lane ending point P2. The speed-changing-lane pre-ending distance S2 is indicated in each of FIGS. 3, 4, and 16. In the case where the speed-changing-lane pre-ending distance S2 becomes the same as or smaller than a predetermined stopping distance D2, the speed-changing-lane-ending-point approaching determination unit 330 makes the own vehicle stop. Because the own vehicle stops before the speed-changing-lane ending point P2, it can be prevented that while it is determined that lane changing (merging) is not feasible, the own vehicle passes through the speed-changing-lane ending point P2 and abnormally approaches another vehicle on the main lane R2.

In this situation, it may be allowed that the stopping distance D2 is a distance through which the speed of the own vehicle E becomes “0” at a time when the present speed Ve thereof is decreased at a predetermined constant acceleration. In other words, the stopping distance D2 is set to a distance through which the own vehicle can stop through not rapid deceleration but smooth deceleration. When lane changing is not feasible, the own vehicle can stop at the speed-changing-lane ending point P2 on the speed-changing lane R1. The predetermined constant acceleration is set to a deceleration value for stopping, set by the traveling control unit, or a value smaller than the deceleration value for stopping. Such speed decreasing through constant deceleration makes it possible that when lane changing (merging) to the main lane R2 is not feasible, the own vehicle smoothly stops at the speed-changing-lane ending point P2, while preventing from being rear-ended by a following vehicle.

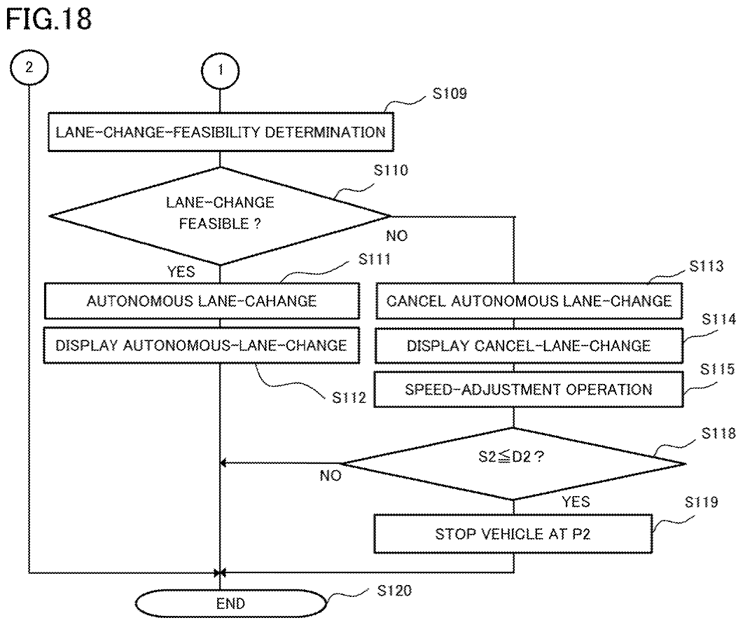

FIG. 18 is a flowchart representing processing by the control apparatus 300c according to Embodiment 4. The flowchart, in FIG. 10, of the processing by the vehicle control apparatus 300c according to Embodiment 4 is followed by the flowchart in FIG. 18. The flowchart in FIG. 18 is different from the flowchart in FIG. 14 according to Embodiment 2 in that respective processing items in the steps S118 and S119 are added after the step S115.

In the step S118, the speed-changing-lane-ending-point approaching determination unit 330 determines whether or not the speed-changing-lane pre-ending distance S2 has become the same as or smaller than the predetermined stopping distance D2. That is to say, it is determined whether or not the own vehicle E has approached the position that is situated before the speed-changing-lane ending point P2 by the stopping distance D2. In the case where the own vehicle E has approached the position that is situated before the speed-changing-lane ending point P2 by the stopping distance D2 (the determination is “YES”), the step S118 is followed by the step S119. In the case where the own vehicle E has not approached the position that is situated before the speed-changing-lane ending point P2 by the stopping distance D2 (the determination is “NO”), the step S118 is followed by the step S120, where the processing is ended.

In the step S119, the traveling control unit 307 controls the actuator 400 so as to make the vehicle stop at the speed-changing-lane ending point P2. Then, the processing is ended in the step S120.

### 5. Embodiment 5

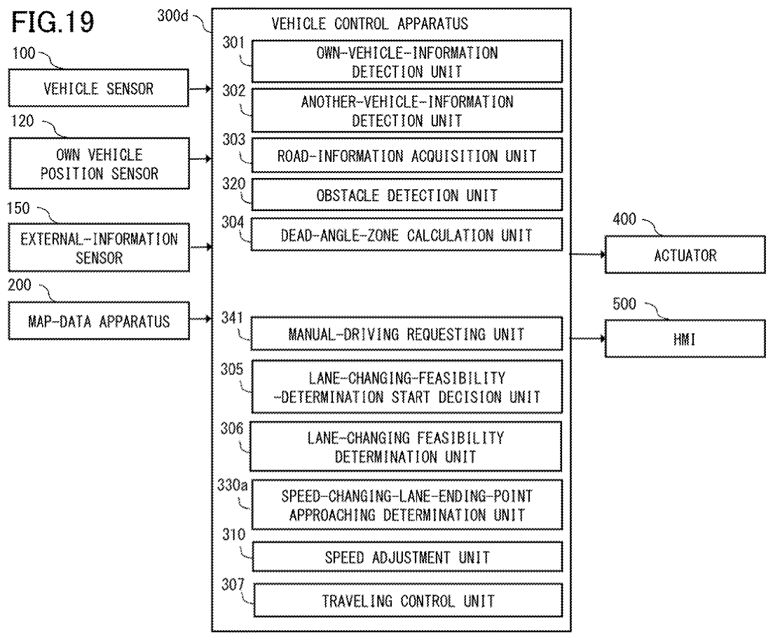

FIG. 19 is a configuration diagram of a vehicle control apparatus 300d according to Embodiment 5. The vehicle control apparatus 300d is different from the vehicle control apparatus 300c, represented in FIG. 17, according to Embodiment 4 in that the speed-changing-lane-ending-point approaching determination unit 330 is replaced by a speed-changing-lane-ending-point approaching determination unit 330a obtained by adding a function to the speed-changing-lane-ending-point approaching determination unit 330 and in that a manual-driving requesting unit 341 is added to the vehicle control apparatus 300d. The explanations for the function units that perform the same operation items as those units according to Embodiments 1 through 4 do will be omitted.

The speed-changing-lane-ending-point approaching determination unit 330a calculates the speed-changing-lane pre-ending distance S2, which is a distance between the present position of the own vehicle E and the speed-changing-lane ending point P2. The speed-changing-lane pre-ending distance S2 is indicated in each of FIGS. 3, 4, and 16. In the case where the speed-changing-lane pre-ending distance S2 has become the same as or smaller than a predetermined manual-driving request distance D1, the speed-changing-lane-ending-point approaching determination unit 330a requests the driver to perform manual driving so that judgement and operation can be entrusted to the driver. When requesting the driver to perform manual driving, the manual-driving requesting unit 341 requests the manual driving through the HMI 500, by means of a display or sound output.

It may be allowed that the manual-driving request distance D1 is a distance larger than the stopping distance D2 explained in Embodiment 4. Accordingly, when the own vehicle approaches a position within the manual-driving request distance D1 of the speed-changing-lane ending point P2, the manual-driving requesting unit 341 can preliminarily request the driver to perform manual driving. Because the judgement is entrusted in a situation where autonomous driving cannot be performed, high-level judgement can be expected. Then, when the own vehicle approaches a position within the stopping distance D2 of the speed-changing-lane ending point P2, the own vehicle E is made to stop at the speed-changing-lane ending point P2, so that the own vehicle E can be prevented from abnormally approaching another vehicle on the main lane R2.

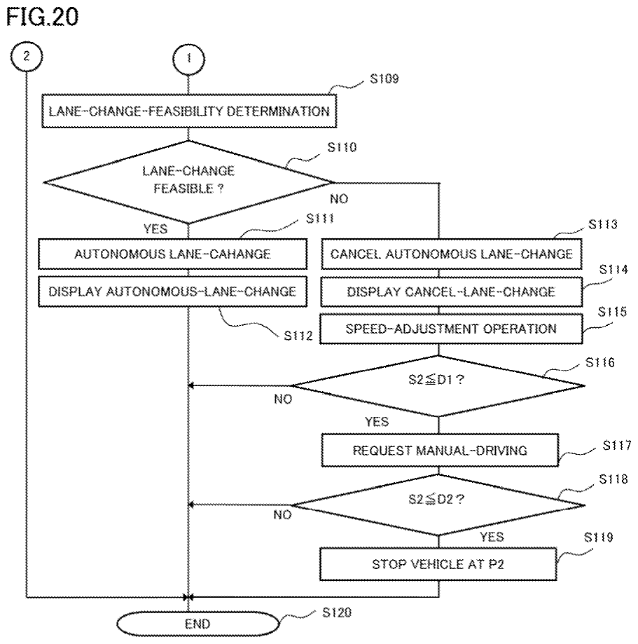

FIG. 20 is a flowchart representing processing by the control apparatus 300d according to Embodiment 5. The flowchart, in FIG. 10, of the processing by the vehicle control apparatus 300d according to Embodiment 5 is followed by the flowchart in FIG. 20. The flowchart in FIG. 20 is different from the flowchart in FIG. 18 according to Embodiment 4 in that respective processing items in the steps S116 and S117 are added between the step S115 and the step S118.

In the step S116, the speed-changing-lane-ending-point approaching determination unit 330a determines whether or not the speed-changing-lane pre-ending distance S2 has become the same as or smaller than the predetermined manual-driving request distance D1. That is to say, it is determined whether or not the own vehicle E has approached the position that is situated before the speed-changing-lane ending point P2 by the manual-driving request distance D1. In the case where the own vehicle E has approached the position that is situated before the speed-changing-lane ending point P2 by the manual-driving request distance D1 (the determination is “YES”), the step S116 is followed by the step S117. In the case where the own vehicle E has not approached the position that is situated before the speed-changing-lane ending point P2 by the manual-driving request distance D1 (the determination is “NO”), the step S116 is followed by the step S120, where the processing is ended.

In the step S117, the manual-driving requesting unit 341 requests the driver to perform manual driving. Specifically, the manual driving is requested through the HMI 500, by means of a display or sound output. Then, the processing is ended in the step S120.

### 6. Embodiment 6

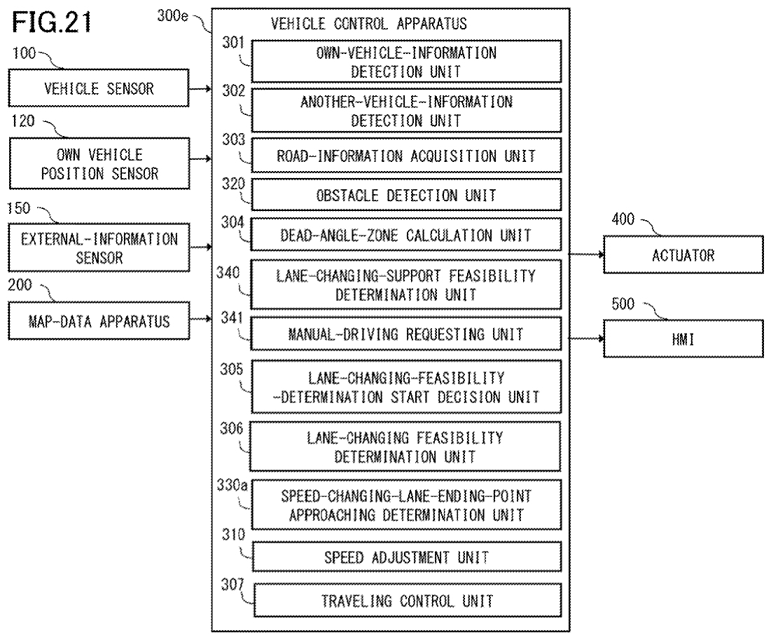

FIG. 21 is a configuration diagram of a vehicle control apparatus 300e according to Embodiment 6. The vehicle control apparatus 300e is different from the vehicle control apparatus 300d, represented in FIG. 17, according to Embodiment 5 in that a lane-changing-support feasibility determination unit 340 is added thereto. The explanations for the function units that perform the same operation items as those units according to Embodiments 1 through 5 do will be omitted.

Based on the speed-changing-lane distance S3, which is the length of the speed-changing lane R1, the lane-changing-support feasibility determination unit 340 determines whether or not lane-changing support is feasible. The distance between the connection starting point P1 and the speed-changing-lane ending point P2 is indicated, as the speed-changing-lane distance S3, in FIG. 3. When the speed-changing-lane distance S3, which is the length of the speed-changing lane R1, is the same as or smaller than a predetermined acceleration-distance threshold value Da3, the lane-changing-support feasibility determination unit 340 determines that lane-changing support is not feasible.

The acceleration-distance threshold value Da3 is defined as the distance in which the speed Ve of the own vehicle E reaches a target speed based on the maximum speed specified on the main lane R2, when at the connection starting point P1, acceleration to the speed Ve of the own vehicle E is continued based on a predetermined constant acceleration (Da3 is not indicated). In this situation, the target speed may be the maximum speed specified on the main lane R2. In addition, it may also be allowed that the target speed is obtained by multiplying the maximum speed specified on the main lane R2 by a predetermined coefficient (for example, 1.2). It is determined whether or not in the speed-changing-lane distance S3, the own vehicle E can be accelerated from the present speed Ve to the target speed at a predetermined constant acceleration.

In the case where the lane-changing-support feasibility determination unit 340 determines that in the speed-changing-lane distance S3, the own vehicle E can be accelerated up to the target speed at the predetermined constant acceleration, it is considered that lane changing is feasible and hence the lane changing (merging) is continued. In the case where the lane-changing-support feasibility determination unit 340 determines that in the speed-changing-lane distance S3, the own vehicle E cannot be accelerated up to the target speed at the predetermined constant acceleration, it is considered that lane changing is not feasible and hence the driver is requested to perform manual driving so that judgement and operation are entrusted to the driver. The predetermined constant acceleration for the own vehicle is set to an acceleration value, set by the traveling control unit, or a value smaller than the acceleration value.

Accordingly, when lane changing (merging) is feasible through smooth acceleration, the lane changing can be implemented. In the case where it can originally be determined that lane changing through smooth acceleration is not feasible, judgement and operation are entrusted to the driver so that higher-level judgement can be expected.

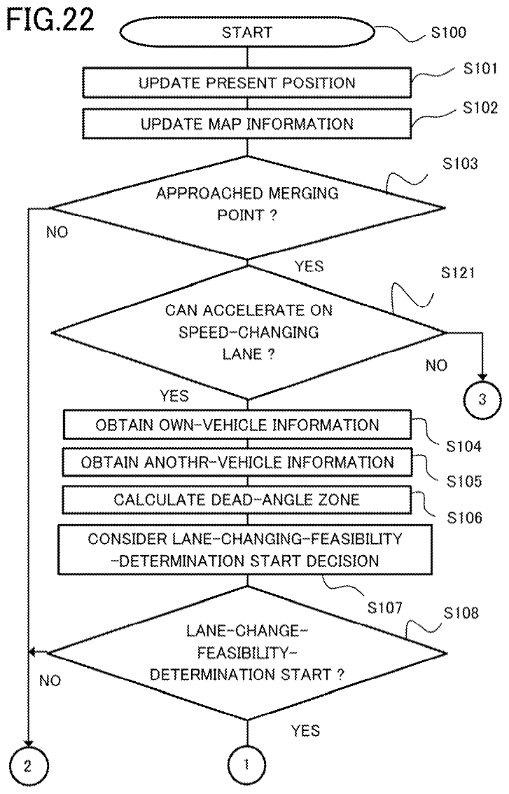

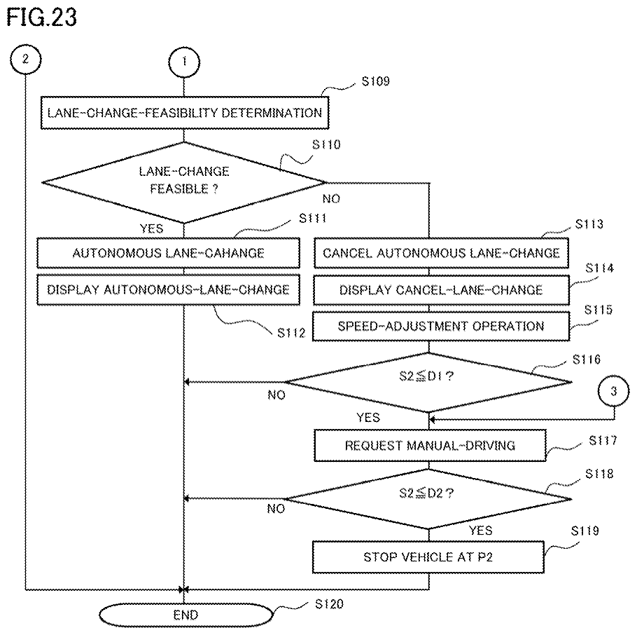

FIG. 22 is a first flowchart representing processing by the control apparatus 300e according to Embodiment 6. FIG. 23 is a second flowchart and represents processing items following those in the flowchart in FIG. 22.

The flowchart in FIG. 22 is different from the flowchart in FIG. 10 according to each of Embodiments 1 through 5 in that processing in the step S121 is added between the step S103 and the step S104. The flowchart in FIG. 23 is different from the flowchart in FIG. 20 according to Embodiment 5 in that the branch line at a time when the determination in the step S121 in FIG. 22 is “NO” is inserted between the step S116 and the step S117.

In the step S121, it is determined whether or not acceleration on an speed-changing lane is feasible. In Embodiment 6, the lane-changing-support feasibility determination unit 340 determines whether or not within the speed-changing-lane distance S3, acceleration up to the target speed can be performed at a predetermined constant acceleration. In the case where the acceleration on the speed-changing lane is feasible (the determination is “YES”), the step S121 is followed by the step S104; then, the conventional determination on lane changing is performed. In the case where the acceleration on the speed-changing lane is not feasible (the determination is “NO”), the step S121 is followed by the step S117 in FIG. 23, where the driver is requested to perform manual driving.

In the present embodiment, the determination on whether or not the acceleration on the speed-changing lane is feasible is made by whether or not within the speed-changing-lane distance S3, acceleration up to the target speed can be performed at a predetermined constant acceleration. However, the speed-changing-lane distance S3 may be replaced by the speed-changing-lane pre-ending distance S2, which is a distance between the present position of the own vehicle E and the speed-changing-lane ending point P2. The speed-changing-lane pre-ending distance S2 is indicated in FIG. 3. Utilization of the speed-changing-lane pre-ending distance S2 makes it possible to determine whether or not acceleration is feasible in an appropriate distance that is available for acceleration in accordance with the position of the own vehicle E.

In the case where the speed-changing-lane distance S3 is replaced by the speed-changing-lane pre-ending distance S2, the determination on whether or not the acceleration on the speed-changing lane is feasible is changed in the step S121 in FIG. 22. It is only necessary that the lane-changing-support feasibility determination unit 340 determines whether or not within the speed-changing-lane pre-ending distance S2, acceleration up to the target speed can be performed at a predetermined constant acceleration.

### 7. Embodiment 7

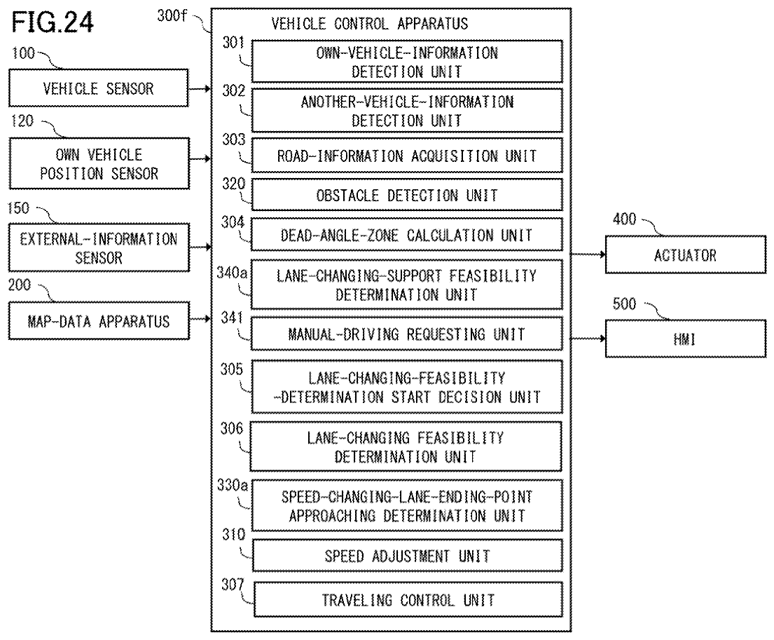

FIG. 24 is a configuration diagram of a vehicle control apparatus 300f according to Embodiment 7. The vehicle control apparatus 300f is different from the vehicle control apparatus 300e, represented in FIG. 21, according to Embodiment 6 in that the lane-changing-support feasibility determination unit 340 is replaced by a lane-changing-support feasibility determination unit 340a. The explanations for the function units that perform the same operation items as those units according to Embodiments 1 through 6 do will be omitted.

In Embodiment 6, it is determined whether or not the lane-changing support is feasible, based on whether or not within the speed-changing-lane distance S3 or the speed-changing-lane pre-ending distance S2, acceleration up to the target speed can be performed at a predetermined constant acceleration. In Embodiment 7, it is determined whether or not the lane-changing support is feasible, based on whether or not within the speed-changing-lane pre-connection distance S1, which is a distance in which the own vehicle E on the communication path R3 reaches the connection starting point P1, acceleration up to a predetermined acceleration preparation speed can be performed at a predetermined constant acceleration. The speed-changing-lane pre-connection distance S1 is indicated in FIG. 3. The predetermined constant acceleration for the own vehicle is set to an acceleration value, set by the traveling control unit, or a value smaller than the acceleration value. The acceleration preparation speed may be determined based on the maximum speed designated for the main lane.

In the case where when entering the speed-changing lane R1, the own vehicle E has been accelerated up to a sufficient acceleration preparation speed in preparation for course changing to (merging with) the main lane, additional acceleration is facilitated in the subsequent course changing to the main lane; thus, the course changing is smoothly performed. When this acceleration is not feasible, the driver is preliminarily requested to perform manual driving. This method makes it possible that the driver preliminarily receives the request for manual driving; thus, the course changing (merging) can be coped with in good time under the condition that preparations therefor have been made.

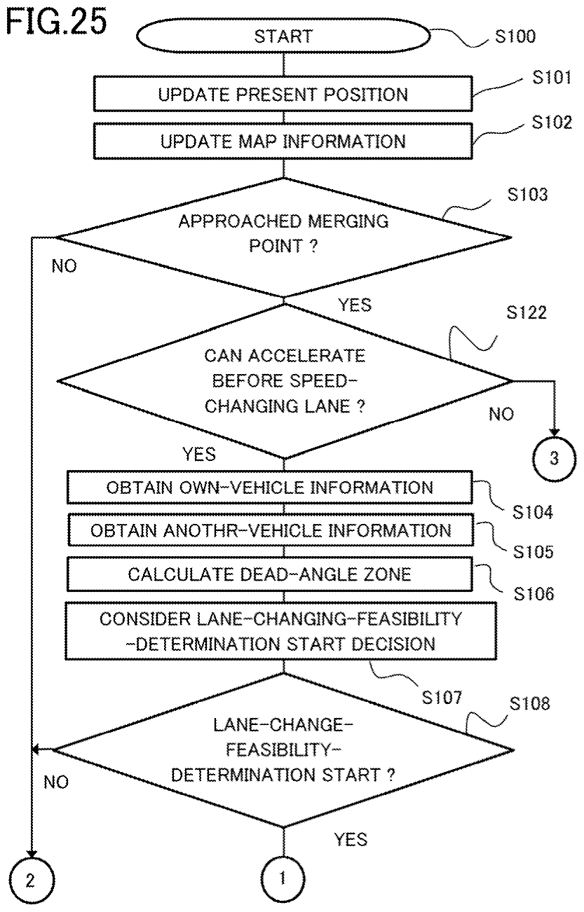

FIG. 25 is a flowchart representing processing by the control apparatus 300f according to Embodiment 7. FIG. 25 follows the processing represented by the flowchart in FIG. 23.

The flowchart in FIG. 25 is different from the flowchart in FIG. 22 according to Embodiment 6 in that the step S121 is replaced by the step S122. In the step S122 in FIG. 25, it is determined whether or not acceleration can be made before the speed-changing lane. In other words, it is determined whether or not lane-changing support is feasible, based on whether or not within the speed-changing-lane pre-connection distance S1, which is a distance in which the own vehicle E on the communication path R3 reaches the connection starting point P1, acceleration up to a predetermined acceleration preparation speed can be performed.

In the case where in the step S122, acceleration up to the acceleration preparation speed can be performed before the speed-changing lane (the determination is “YES”), the step S122 is followed by the step S104; then, the conventional determination on lane changing is performed. In the case where acceleration up to the acceleration preparation speed cannot be performed before the speed-changing lane (the determination is “NO”), the step S122 is followed by the step S117 in FIG. 23, where the driver is requested to perform manual driving.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the specification of the present disclosure. For example, there are included the case where at least one constituent element is modified, added, or omitted and the case where at least one constituent element is extracted and then combined with constituent elements of other embodiments.

### DESCRIPTION OF REFERENCE NUMERALS

100: vehicle sensor
120: own-vehicle positon sensor
150: external-information sensor
200: map-data apparatus
300, 300a, 300b, 300c, 300d, 300e, 300f: vehicle control apparatus
301: own-vehicle-information detection unit
302: another-vehicle-information detection unit
303: road-information acquisition unit
304: dead-angle-zone calculation unit
305: lane-changing-feasibility-determination start decision unit
306: lane-changing feasibility determination unit
307: traveling control unit
310: speed adjustment unit
320: obstacle detection unit
330, 330a: speed-changing-lane-ending-point approaching determination unit
340, 340a: lane-changing-support feasibility determination unit
341: manual-driving requesting unit
400: actuator
500: HMI

What is claimed is:

1. A vehicle control apparatus comprising:
an own-vehicle-information detector for detecting a position and a speed of an own vehicle that performs lane changing from one lane to another lane;
an another-vehicle-information detector for detecting a position and a speed of another vehicle traveling on said another lane, by means of a sensor provided in the own vehicle;
a road-information acquisitor for acquiring road information indicating respective road positions that specify the one lane and said another lane;
a dead-angle-zone calculator for calculating a dead-angle zone that is a zone within a dead angle on said another lane when viewed from the own vehicle, based on the road information acquired by the road-information acquisitor and a position of the own vehicle detected by the own-vehicle-information detector;
a lane-changing-feasibility-determination start decider for deciding to start a lane-changing feasibility determination, based on a position of the own vehicle and a position of an imaginary vehicle imagined at a position that is within the dead-angle zone calculated by the dead-angle-zone calculator and is nearest to the own vehicle;
a lane-changing feasibility determinator for determining whether or not lane changing is feasible, based on a position and a speed of the own vehicle and a position and a speed of said another vehicle, in the case where the lane-changing-feasibility-determination start decider decides to start a lane-changing feasibility determination; and
a traveling controller for making the own vehicle perform lane changing to another lane, in the case where the lane-changing feasibility determinator determines that lane changing is feasible.

2. The vehicle control apparatus according to claim 1, wherein the dead-angle-zone calculator calculates the dead-angle zone, based on a position of the own vehicle and a position of a connection starting point that is acquired by the road-information acquisitor and at which connection between the one lane and said another lane is started.

3. The vehicle control apparatus according to claim 1, wherein the lane-changing-feasibility-determination start decider decides to start a lane-changing feasibility determination, based on a position and a speed of the own vehicle and a position and a speed of the imaginary vehicle.

4. The vehicle control apparatus according to claim 3, wherein in the case where an imaginary inter-vehicle distance that is a distance between a position of the own vehicle and a position of the imaginary vehicle is larger than an imaginary inter-vehicle distance threshold value calculated based on an imaginary approaching speed that is a difference between a speed of the own vehicle and a speed of the imaginary vehicle, the lane-changing-feasibility-determination start decider decides to start a lane-changing feasibility determination.

5. The vehicle control apparatus according to claim 3, wherein the lane-changing-feasibility-determination start decider estimates a speed of the imaginary vehicle, based on a speed of said another vehicle detected by the another-vehicle-information detector.

6. The vehicle control apparatus according to claim 3,
wherein the road-information acquisitor acquires road information indicating respective road positions that specify the one lane and said another lane and a maximum speed designated for each of the lanes, and
wherein the lane-changing-feasibility-determination start decider estimates a speed of the imaginary vehicle, based on a designated maximum speed of said another lane acquired by the road-information acquisitor.

7. The vehicle control apparatus according to claim 1, wherein in the case where the another-vehicle-information detector detects said another vehicle after a projection position where a positon of the own vehicle is projected on said another lane, the lane-changing-feasibility-determination start decider decides to start a lane-changing feasibility determination.

8. The vehicle control apparatus according to claim 1, wherein in the case where the another-vehicle-information detector detects following another vehicle after a projection position where a positon of the own vehicle is projected on said another lane and in the case where a rear inter-vehicle distance that is a distance between a position of the own vehicle and a position of the following another vehicle is smaller than a rear inter-vehicle distance threshold value calculated based on a rear approaching speed that is a difference between a speed of the own vehicle and a speed of the following another vehicle, the lane-changing feasibility determinator determines that lane changing is not feasible.

9. The vehicle control apparatus according to claim 1, wherein in the case where the another-vehicle-information detector detects preceding another vehicle before a projection position where a positon of the own vehicle is projected on said another lane and in the case where a front inter-vehicle distance that is a distance between a position of the own vehicle and a position of the preceding another vehicle is smaller than a front inter-vehicle distance threshold value calculated based on a front approaching speed that is a difference between a speed of the own vehicle and a speed of the preceding another vehicle, the lane-changing feasibility determinator determines that lane changing is not feasible.

10. The vehicle control apparatus according to claim 1, further comprising a speed adjuster that calculates a lane-changing permission speed that is a speed of the own vehicle and with which it is determined that lane changing is feasible and that adjusts a speed of the own vehicle to the lane-changing permission speed, when the lane-changing feasibility determinator determines that lane changing is not feasible.

11. The vehicle control apparatus according to claim 1, further comprising an obstacle detector that detects an obstacle provided on the one lane or said another lane, by means of a sensor provided in the own vehicle, wherein the dead-angle-zone calculator calculates a dead-angle zone on said another lane, based on the position of the obstacle that is provided on the one lane or said another lane and has been detected by the obstacle detector.

12. The vehicle control apparatus according to claim 1, wherein in the case where the lane-changing feasibility determinator determines that lane changing is not feasible and in the case where the distance between a position of the own vehicle and an ending point of the one lane becomes the same as or smaller than a predetermined stopping distance, the traveling controller makes the own vehicle stop.

13. The vehicle control apparatus according to claim 1, further comprising a manual-driving requester that requests a driver to perform manual driving, in the case where the lane-changing feasibility determinator determines that lane changing is not feasible and in the case where the distance between a position of the own vehicle and an ending point of the one lane becomes the same as or smaller than a predetermined stopping distance.

14. The vehicle control apparatus according to claim 1, further comprising:
a lane-changing-support feasibility determinator that determines whether or not it is feasible to accelerate the own vehicle up to a target speed calculated based on a speed of said another vehicle detected by the another-vehicle-information detector or a designated maximum speed of said another lane, in the case where the own vehicle is accelerated at predetermined own-vehicle acceleration while traveling in a distance between an ending point of the one lane and a positon of a connection starting point where connection between the one lane and said another lane acquired by the road-information acquisitor starts, and
a manual-driving requester that requests a driver to perform manual driving, when the lane-changing-support feasibility determinator determines that acceleration is not feasible.

15. The vehicle control apparatus according to claim 1, the road-information acquisitor acquiring road information indicating respective road positions that specify the one lane and said another lane and a maximum speed designated for each of the lanes, and the vehicle control apparatus further comprising:
a lane-changing-support feasibility determinator that determines whether or not it is feasible to accelerate the own vehicle up to a target speed calculated based on a speed of said another vehicle detected by the another-vehicle-information detector or a designated maximum speed of said another lane, acquired by the road-information acquisitor, in the case where the own vehicle is accelerated at predetermined own-vehicle acceleration while traveling in a distance between a position of the own vehicle detected by the own-vehicle-information detector and an ending point of the one lane acquired by the road-information acquisitor, and
a manual-driving requester that requests a driver to perform manual driving, when the lane-changing-support feasibility determinator determines that acceleration is not feasible.

16. The vehicle control apparatus according to claim 1, the road-information acquisitor acquiring road information indicating respective road positions that specify the one lane and said another lane and a maximum speed designated for each of the lanes, and the vehicle control apparatus further comprising:
a lane-changing-support feasibility determinator that determines whether or not it is feasible to accelerate the own vehicle up to an acceleration preparation speed calculated based on a designated maximum speed of said another lane, acquired by the road-information acquisitor, in the case where the own vehicle is accelerated at predetermined own-vehicle acceleration while traveling in a distance between a position of the own vehicle detected by the own-vehicle-information detector and a connection starting point where connection between the one lane and said another lane starts, and
a manual-driving requester that requests a driver to perform manual driving, when the lane-changing-support feasibility determinator determines that acceleration is not feasible.
